(19) United States
(12) Patent Application Publication
(10) Pub. No.: US 2014/0184461 A1
(43) Pub. Date: Jul. 3, 2014

(54) Antenna Assembly

(71) Applicants: JungMin Kim, Suwon (KR); Jinwook Seo, Suwon (KR); Junghoon Chae, Suwon (KR)

(72) Inventors: JungMin Kim, Suwon (KR); Jinwook Seo, Suwon (KR); Junghoon Chae, Suwon (KR)

(21) Appl. No.: 13/732,413

(22) Filed: Jan. 1, 2013

(51) Int. Cl. H01Q 7/00; H01Q 7/06

(52) U.S. Cl. CPC H01Q 7/00; H01Q 7/06
USPC 343/788; 343/870; 343/867

(57) ABSTRACT

An antenna assembly includes a substrate including a first surface and a second surface, an antenna coil attached to the first surface of the substrate and including a number of pins, a flexible printed circuit board including a number of first contacts electrically connected to the pins, wherein the substrate is disposed in a same plane with the flexible printed circuit board.

### FIELD OF THE INVENTION

The present disclosure relates to communication technology, and more specifically to an antenna assembly for a near field communication device.

### DESCRIPTION OF RELATED ART

Near field communication (NFC) traces its roots back to radio-frequency identification (RFID). NFC is a set of short-range wireless technologies, typically requiring a distance of 4 cm or less. NFC operates at 13.56 MHz on ISO/IEC 18000-3 air interface and at rates ranging from 106 kbit/s to 424 kbit/s, which is much faster than infrared transmission and safer than Bluetooth.

NFC is a set of standards for smartphones and similar devices to establish radio communication with each other by touching them together or bringing them into close proximity, usually no more than a few centimetres. Present and anticipated applications include contactless transactions, data exchange, and simplified setup of more complex communications. Communication is also possible between an NFC device and an unpowered NFC chip, called a “tag”.

NFC devices can be used in contactless payment systems, similar to those currently used in credit cards and electronic ticket smartcards, and allow mobile payment to replace or supplement these systems.

A related NFC device includes an antenna determining the performance of the near-field communication distance as well as the NFC electronic terminal machine. A related antenna is made of planar coils with big size and thickness. However, the antenna could only be attached to a back cover of a mobile, which would limit the configuration of the antenna and increasing the size of the mobile.

Therefore, it is desirable to provide a new antenna which can overcome the above-mentioned problems.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 shows an isometric and exploded view of an antenna assembly in accordance with an exemplary embodiment of the present disclosure;

FIG. 2 shows an assembly of an antenna coil and an FPCB;

FIG. 3 shows an isometric and exploded view of the antenna coil, the FPCB and a substrate.

### DETAILED DESCRIPTION OF THE EMBODIMENT

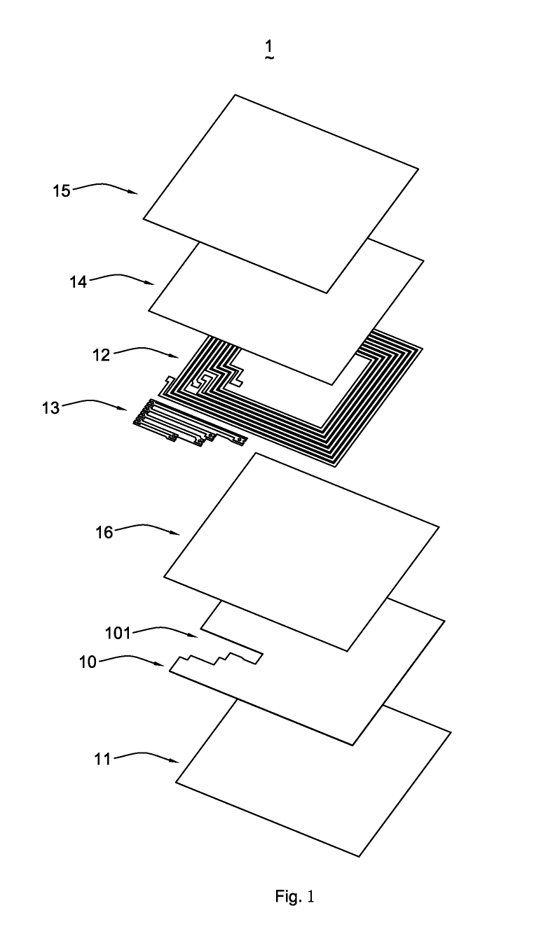

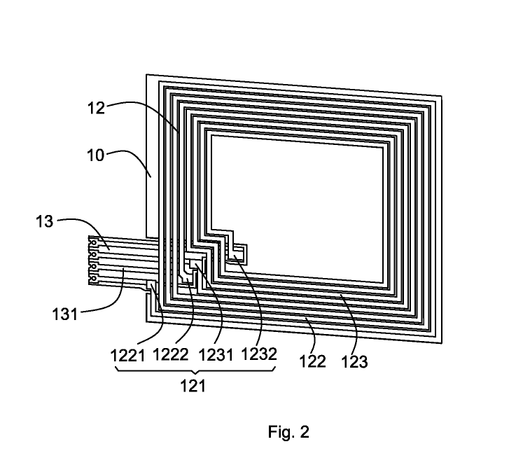

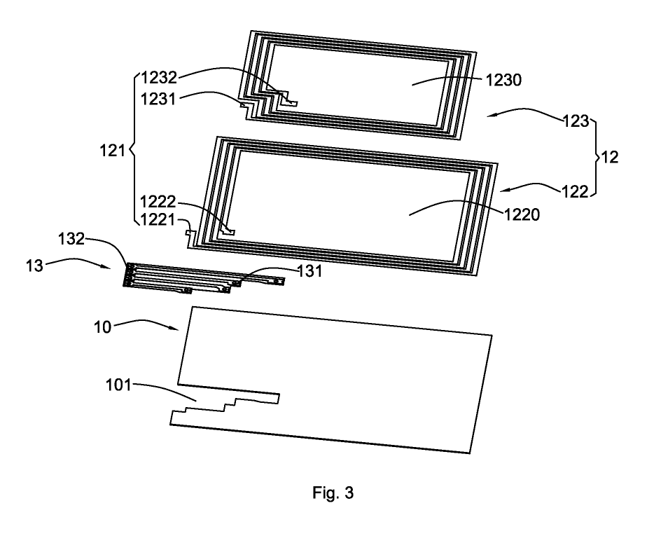

Referring to FIGS. 1-3, an antenna assembly 1 comprises a substrate 10 including a first surface and a second surface, an antenna coil 12 disposed on the first surface of the substrate 10, a first adhesive layer 11 disposed on the second surface of the substrate 10, a flexible printed circuit board (FPCB) 13 electrically connected to the antenna coil 12, a second adhesive layer 14 attached to an upper face of the antenna coil 12, a cover layer 15 disposed on an upper face of the second adhesive layer 14, and an optional third adhesive layer 16 disposed between the antenna 12 and the substrate 10.

The first, second, and third adhesive layers 11, 14, 16 are double adhesive layers, but they could be other adhesive material in other embodiments.

The substrate 10 is made from ferrite material. The cover layer 15 is used for protecting the antenna assembly 1 from mechanical and environmental damage. The antenna assembly 1 could be mounted to a subject device by the first adhesive layer 11.

The antenna coil 12 includes a first coil 122 enclosing a first area 1220, and a second coil 123 disposed within the first area 1220 and enclosing a second area 1230. Each of the first and second coils 122,123 is round by a metallic wire. The first coil 122 and the second coil 123 are disposed in a same plane.

The antenna coil 12 further includes a plurality of pins 121 for transferring electrical signals. The pins 121 include a first pin 1221 and a second pin 1222 disposed at two free ends of the first coil 122, a third pin 1231 and a fourth pin 1222 disposed at two free ends of the second coil 122. The first pin 1221 is located outside of the first area 1220, the fourth pin 1232 is located within the second area 1230. The second pin 1222 and the third pin 1231 are disposed between the first coil 121 and the second coil 122.

The FPCB 13 includes a plurality of first contacts 131 disposed at one end thereof and electrically connected to the pins 121 of the antenna coil 12, and a plurality of second contacts 132 disposed at another end thereof and electrically connected to the first contacts 131. The first contacts 131 form a pattern corresponding to the configuration of the pins 121. The second contacts 132 are arranged in a row and disposed outside of the antenna coil 12. Therefore, it is much easier to solder the second contacts 132 to the exterior circuit than soldering the pins 121 directly to the exterior circuit. The first contacts 131 are soldered to the pins 121.

The substrate 10 forms a notch 101 at the periphery thereof for partially receiving the FPCB 13. The notch 101 has a similar outline with the FPCB 13, so that the substrate 10 and the FPCB 13 are disposed in a same plane and the total thickness of the antenna assembly 1 remains.

Optionally, the antenna 12 may include a single coil or more than two coils, and the rounds, the width of the wire of the coils could be changed. Then the distance between the first pin 1221 and the second pin 1222, and the distance between the third pin 1221 and the fourth pin 1222 could be changed. It is simple and cheap to satisfy various needs for the different configuration of the pins 121 by changing the FPCB 13.

In this embodiment, the antenna assembly is used in a NFC device. In fact, the disclosed antenna assembly may be used in any device with the function of communication.

It will be understood that the above-mentioned particular embodiments is shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. An antenna assembly, comprising:
a substrate including a first surface and a second surface;
an antenna coil attached to the first surface of the substrate and including a plurality of pins;
a flexible printed circuit board including a plurality of first contacts electrically connected to the pins; wherein
the substrate is disposed in a same plane with the flexible printed circuit board.

2. The antenna assembly as claimed in claim 1, wherein the substrate further includes an notch at the periphery thereof for partially receiving the flexible printed circuit board.

3. The antenna assembly as claimed in claim 2, wherein the flexible printed circuit board further includes a plurality of second contacts electrically connecting to the first contacts and arranging in a row.

4. The antenna assembly as claimed in claim 3, wherein the second contacts of the flexible printed circuit board are disposed outside of the substrate, the first contacts are disposed within the notch of the substrate and soldered to the pins of the antenna coil.

5. The antenna assembly as claimed in claim 1, wherein the antenna coil includes a first coil with a plurality of rounds and enclosing a first area, and a second coil with a plurality of rounds and enclosing a second area, the second coil is disposed within the first area, the first coil is disposed in a same plane with the second coil.

6. The antenna assembly as claimed in claim 5, wherein the pins of the antenna coil includes a first pin and a second pin disposed at two free ends of the first coil, a third pin and a fourth pin disposed at two free ends of the second coil.

7. The antenna assembly as claimed in claim 6, wherein the first pin are disposed outside of the first area, the fourth pin are disposed within the second area, the second and third pins are disposed between the first coil and the second coil.

8. The antenna assembly as claimed in claim 1, further including a first adhesive layer disposed at the second surface of the substrate, a second adhesive layer attached to an upper face of the antenna coil, and a cover layer disposed on an upper face of the second adhesive layer.

9. The antenna assembly as claimed in claim 8, further including a third adhesive layer disposed between the antenna and the substrate.

10. The antenna assembly as claimed in claim 1, wherein the substrate is made from ferrite material.

11. An antenna assembly, comprising:
a substrate, including a first surface and a second surface, and a notch disposed at a periphery thereof;
an antenna coil attached to the first surface of the substrate and including a plurality of pins;
a flexible printed circuit board partially receiving in the notch, including a plurality of first contacts electrically connected to the pins of the antenna coil and a plurality of second contacts electrically connected to the first contacts; wherein
the second contacts are arranged in a row and disposed outside of the substrate.

12. The antenna assembly as claimed in claim 11, wherein the flexible printed circuit board is disposed in a same plane with the substrate.

13. The antenna assembly as claimed in claim 11, further including a first adhesive layer disposed at the second surface of the substrate, a second adhesive layer attached to an upper face of the antenna coil, and a cover layer disposed on an upper face of the second adhesive layer.

14. The antenna assembly as claimed in claim 13, further including a third adhesive layer disposed between the antenna and the substrate.

15. The antenna assembly as claimed in claim 11, wherein the substrate is made from ferrite material.

16. An antenna assembly, comprising:
a substrate, including a first surface and a second surface;
an antenna coil attached to the first surface of the substrate, including at least two coils and a plurality of pins;
a flexible printed circuit board partially, including a plurality of first contacts electrically connected to the pins and a plurality of second contacts electrically connected to the first contacts; wherein
the second contacts are disposed outside of the substrate, and the at least two coils are disposed at a same plane.

17. The antenna assembly as claimed in claim 16, wherein further including a first adhesive layer disposed at the second surface of the substrate, a second adhesive layer attached to an upper face of the antenna coil, a third adhesive layer disposed between the antenna and the substrate and a cover layer disposed on an upper face of the second adhesive layer.
